(19) United States
(12) Patent Application Publication
(10) Pub. No.: US 2009/0146119 A1
(43) Pub. Date: Jun. 11, 2009

(54) Method and means for providing an accessory mounting point at the forward end of an all-terrain vehicle

(76) Inventors: Alan D. Bailey, Spirit Lake, IA (US); Randy J. Kempf, Wahpeton, IA (US)

Correspondence Address: THOMTE LAW OFFICE, L.L.C., 2120 S. 72ND STREET, SUITE 1111, OMAHA, NE, 68124, US

(21) Appl. No.: 12/001,225

(22) Filed: Dec. 11, 2007

(51) Int. Cl. B66D 1/00; E02F 3/815; B23P 11/00

(52) U.S. Cl. 254/323; 37/407; 29/428

(57) ABSTRACT

A method and means for providing an accessory mounting point at the forward end of an all-terrain vehicle wherein an accessory mounting bracket is secured to a winch fairlead which may be a conventional fairlead or a roller fairlead. The accessory mounting bracket is normally positioned between the ATV winch and the fairlead and is held in place by bolts extending from the winch or the winch mounting bracket through the accessory mounting bracket and then through the fairlead.

### BACKGROUND OF THE INVENTION

1. Field of the Invention

This invention relates to a method and means for providing an accessory mounting point at the forward end of an all-terrain vehicle and which more particularly relates to a method and means for providing an accessory mounting point which is associated with the winch roller fairlead mounted at the forward end of the vehicle.

2. Description of the Related Art

The attachment of certain accessories such as a basket, gun rack, tool rack, etc., to the top of an all-terrain vehicle (ATV) is sometimes difficult and requires that the same be attached to the front bumper with the bumper design varying between different manufacturers and different models of those manufacturers. Thus, the attachment of those accessories to the vehicle normally requires customization of the accessories to a particular make and/or model of the ATV. Further, the attachment of other accessories to the ATV may be troublesome due to the fact that the accessory must be attached or secured to a robust part of the ATV such as the frame.

Many ATVs are equipped with a winch at the forward end thereof with the winch being secured to the frame of the ATV by a mounting bracket in a manner which will withstand the large winching forces applied thereto during winching operations. Most, if not all, of the ATVs which have winches mounted thereon will also have a winch roller fairlead secured to the winch itself or to the winch mounting bracket so that the winch roller fairlead is positioned forwardly of the winch with the winch cable extending therethrough. The winch roller fairlead is sometimes called a winch roller hawse or winch roller hauser and is designed to protect the winch cable or wire rope from excessive wear since it reduces binding and friction caused by angled pulls. The winch roller fairlead must be necessarily mounted to the winch itself or to the winch mounting bracket in a substantially robust manner. Applicants have discovered that the winch roller fairlead is a very convenient and secure attachment point for securing accessories to the ATV. In particular, applicants have discovered that the winch roller fairlead is ideally suited, with the addition of an auxiliary bracket, to support one end of a down pressure device for a push blade secured to the ATV.

### SUMMARY OF THE INVENTION

The method and means for providing an accessory mounting point at the forward end of an ATV is described. The method of creating an accessory attachment point at the forward end of an ATV, having a winch roller fairlead secured thereto which is positioned forwardly of a winch which is secured to the vehicle by a winch mounting bracket and which has a winch cable extending therefrom which is extended through the winch roller fairlead, comprises the step of attaching an accessory mounting bracket to the winch roller fairlead with the accessory mounting bracket including accessory attachment mounting structure thereon. The attachment method may include the step of attaching the accessory mounting bracket to the winch mounting bracket. The attachment method may also include the step of positioning the accessory mounting bracket between the winch and the winch roller fairlead.

The means for providing an accessory mounting point at the forward end of an all-terrain vehicle is the fabrication of an accessory mounting bracket which is positioned between the winch and the winch roller fairlead and which is secured to the winch mounting bracket or to the winch. An accessory may be attached to the accessory mounting bracket. In one example thereof, one end of a down pressure device such as a gas spring is pivotally connected to the accessory mounting bracket with the other end thereof being operatively connected to a push blade structure secured to the ATV at the forward end thereof.

The accessory mounting bracket also provides a secure and robust accessory mounting point to enable accessories such as a basket, snow plow, snow blower, gun rack, tool rack, hook attachment, pull point, tow point, alignment device, etc., to be secured thereto.

It is therefore a principal object of the invention to provide a method and means for providing an accessory mounting point at the forward end of an all-terrain vehicle.

A further object of the invention is to provide a method and means for providing an accessory mounting point at the forward end of an all-terrain vehicle which does not require extensive modification of the vehicle.

Still another object of the invention is to provide means for providing an accessory mounting point at the forward end of an all-terrain vehicle by positioning an accessory mounting bracket between the winch and winch roller fairlead of the vehicle.

Yet another object of the invention is to provide a means for providing an accessory mounting point at the forward end of an all-terrain vehicle by fabricating a mounting bracket which may be secured to the winch mounting bracket or to the winch.

These and other objects will be apparent to those skilled in the art.

### BRIEF DESCRIPTION OF THE DRAWINGS

FIG. 1 is a front perspective view of an all-terrain vehicle having the structure of the invention mounted thereon;

FIG. 2 is a partial side view of the vehicle of FIG. 1;

FIG. 3 is a perspective view of the accessory mounting bracket of this invention which illustrates the relationship of the bracket to a winch roller fairlead;

FIG. 4 is a front perspective view of the vehicle winch, the accessory mounting bracket and the winch roller fairlead;

FIG. 5 is a front perspective view of an all-terrain vehicle which illustrates an accessory in the form of a basket secured to the OEM front rack of the vehicle utilizing the accessory mounting bracket of this invention; and

FIG. 6 is a partial side view of the structure of FIG. 5.

### DESCRIPTION OF THE PREFERRED EMBODIMENT

The numeral 10 refers to an all-terrain vehicle (ATV) of conventional design which includes a forward end 12 and a rearward end 14. The ATV 10 normally has a brush guard or bumper 16 positioned at the forward end 12 which secured to the frame of the vehicle. The vehicle also normally includes an OEM front rack 17. The vehicle 10 may be a two wheel drive vehicle or a four wheel drive vehicle.

Most ATVs are equipped with a winch 18 having a winch cable 20 extending therefrom. The winch 18 is an electric winch and is driven by the vehicle electrical system. Winch 18 is normally secured to the frame of the vehicle by a conventional mounting bracket but the winch 18 may sometimes be secured to the bumper of the vehicle. The numeral 24 refers to a winch roller fairlead which is normally secured to the winch itself or the winch mounting bracket. In some cases, the winch roller fairlead 24 is spaced forwardly of the winch 18 and is secured to the frame or bumper of the vehicle. In some cases, the fairlead 24 is not a winch roller fairlead but is a plate-like fairlead having a central opening formed therein through which the winch cable extends.

Inasmuch as the winch cable 20 is sometimes used to pull logs or the like or to pull the vehicle through a muddy or rough area, the winch 18 and the fairlead 24 are robustly mounted on the vehicle so as to withstand the pulling forces exerted thereon. Applicants have discovered that inasmuch as the fairlead 24 is robustly attached to the vehicle frame or to the winch 18 which is robustly attached to the vehicle frame or bumper, that the fairlead 24 provides a unique attachment point for securing ATV accessories thereto.

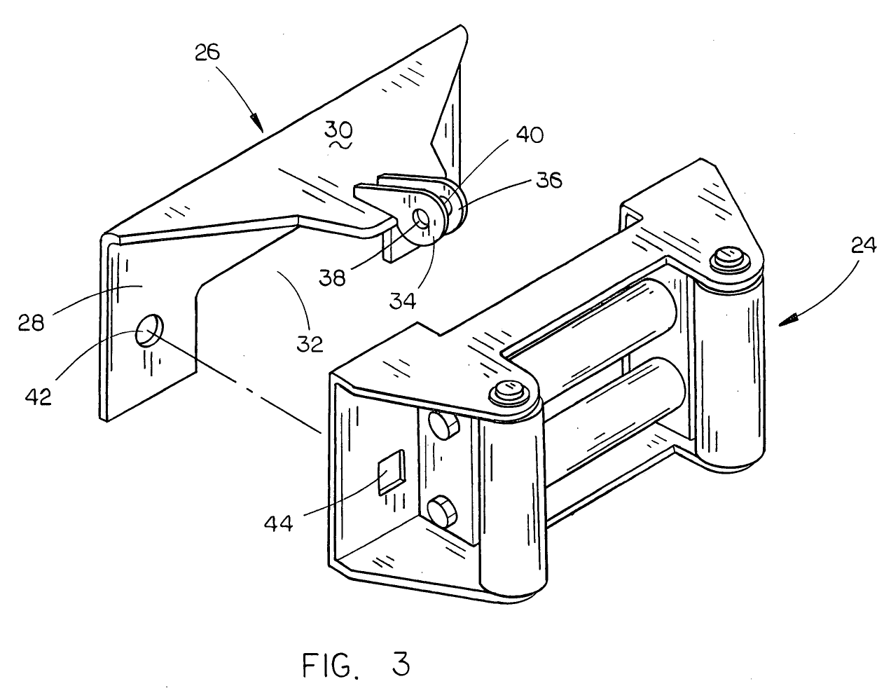

The numeral 26 refers to an accessory mounting bracket which is operatively secured to the fairlead 24. Bracket 26 includes a back or base plate 28 and a top plate 30 which extends forwardly from the upper end of plate 28. Plate 28 has a central opening 32 formed therein. A pair of spaced-apart ears 34 and 36 are provided at the forward end of plate 30, as seen in FIG. 3. Ears 34 and 36 are provided with openings 38 and 40 formed therein, respectively. If the fairlead 24 is secured directly to the winch mounting bracket 22 or to the winch 18 itself, the accessory mounting bracket 26 is positioned therebetween and is provided with a pair of bolt openings 42 formed therein which register with the bolt openings 44 in the fairlead 24 so that the bracket 26 is securely positioned between the fairlead 24 and the winch 18 or the mounting bracket 22 by bolts 46. If the fairlead 24 is mounted on the frame or bumper forwardly of the winch 18, in a spaced-apart relationship, the mounting bracket 26 is positioned between the fairlead 24 and the frame or bumper. In any case, the accessory mounting bracket 26 is an extremely durable attachment point to which accessories may be secured. In one embodiment of the mounting bracket 26, the ears 34 and 36 are adapted to receive a pin or pivot pin 48 therein. Structure other than the ears 34 and 36 may sometimes be used to attach various accessories thereto.

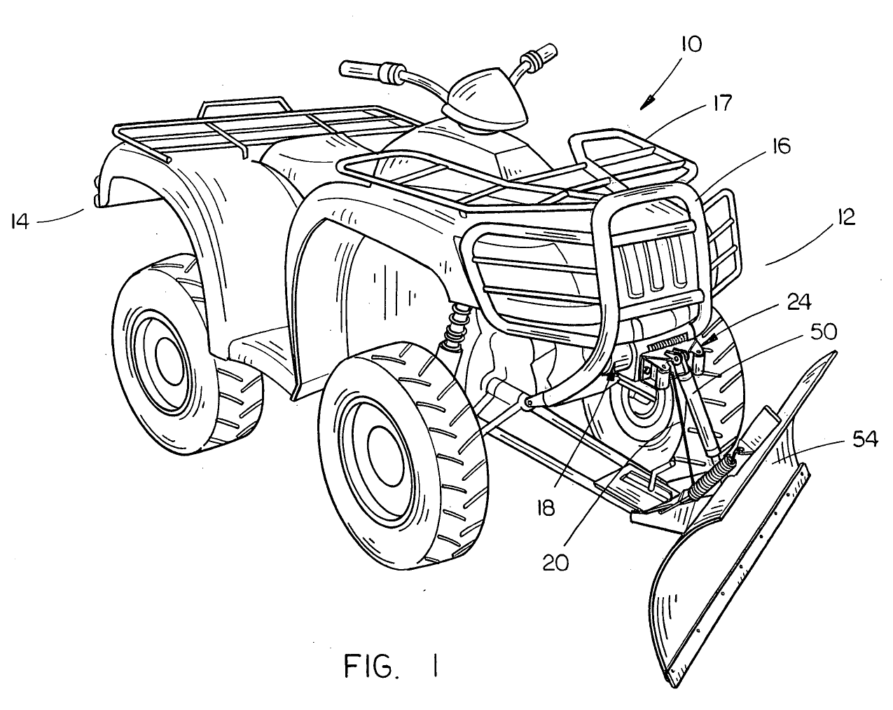

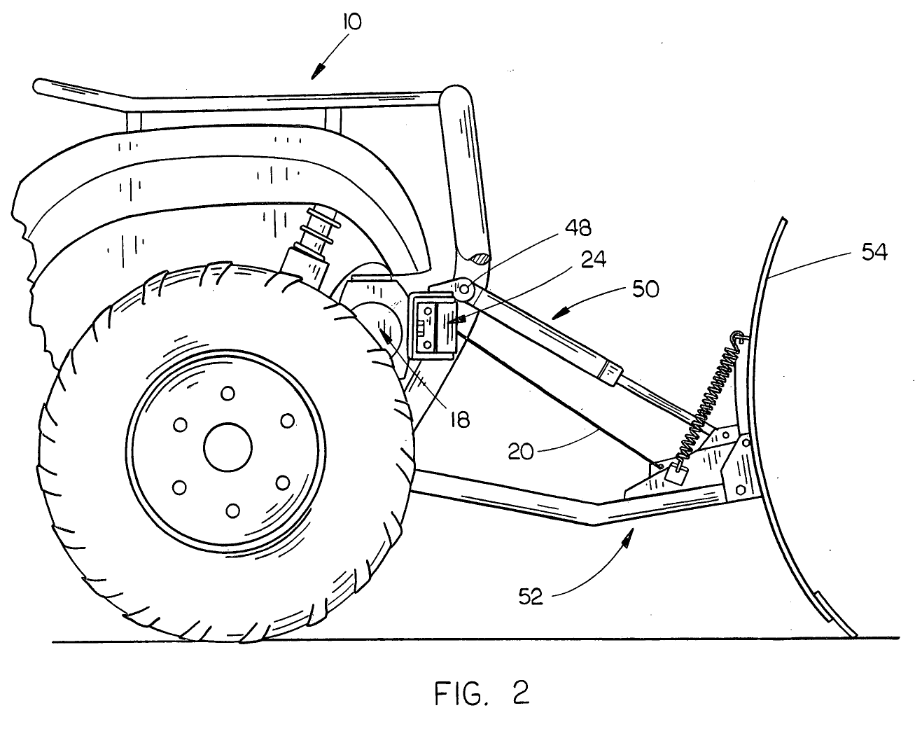

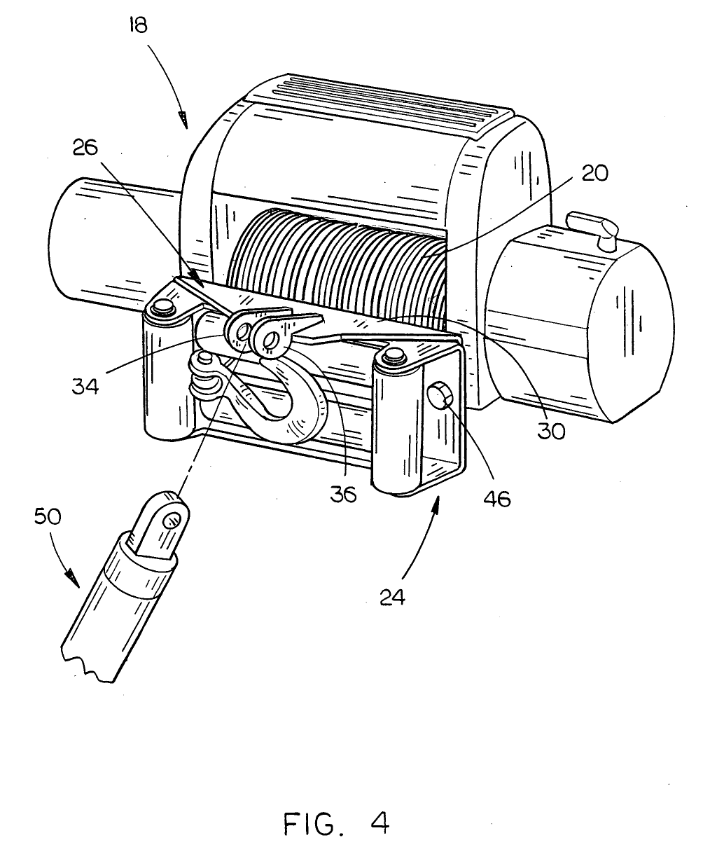

FIGS. 1, 2 and 4 illustrate one type of accessory that may be utilized in connection with the accessory mounting bracket 26. In FIGS. 1, 2 and 4, the numeral 50 refers to a down pressure device or member which is preferably of the gas cylinder type. The upper end of the down pressure device 50 is pivotally connected to the ears 36 and 38 by the pin 48 with the lower end of the down pressure device 50 being pivotally secured to some part of the push blade accessory 52 mounted at the forward end of the vehicle 10 to exert downward pressure on the blade 54.

Other types of accessories may be secured to the accessory mounting bracket 26. For example, the mounting bracket 26 may be used as an attachment point for the hook 56 of the winch cable 20 to store the hook. The accessory mounting bracket 26 may be also used as a point to pull or tow the ATV and may be used as a “recovery point” by hooking the cable 20 onto a tree and routing the cable 20 back to a snatch block or “D” ring mounted on the accessory mounting bracket 26 which provides a centrally located point from which to pull. Further, the accessory mounting bracket 26 may be used to attach a plow or other front-mounted accessory which is simpler than a “belly” mounted system. Further, the bracket 26 may have an alignment device secured thereto to facilitate the drive-up front mounted plow system.

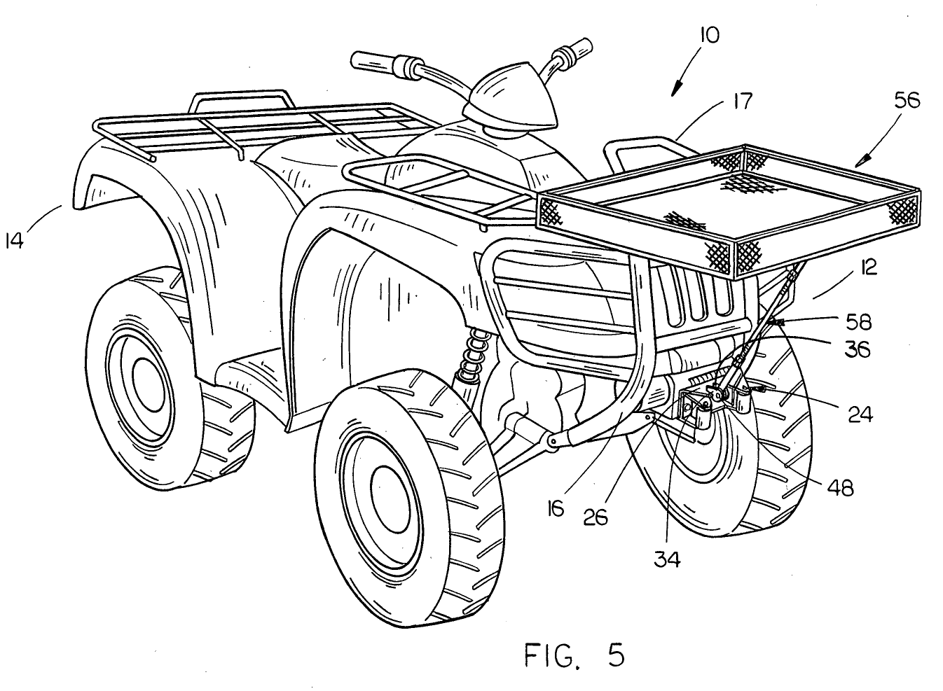

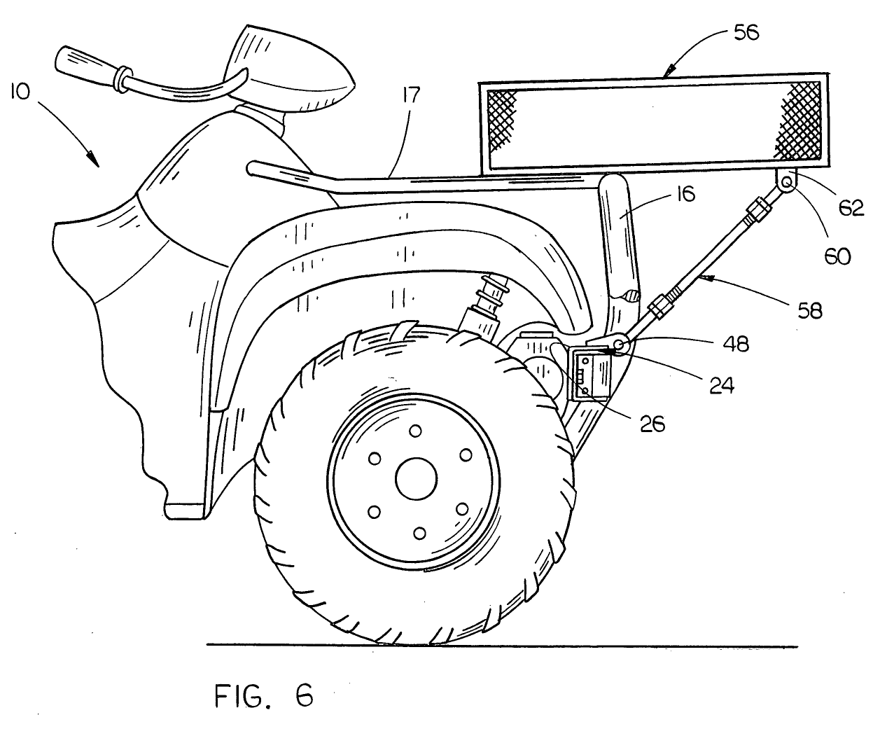

FIGS. 5 and 6 illustrate another form of accessory which may be secured to the vehicle utilizing the mounting bracket 26 which is attached to the fairlead 24 in the same manner as previously described. In FIGS. 5 and 6, the numeral 56 refers to a basket which is attached to the OEM rack 17 at the forward end of the ATV 10. The rearward end of the basket 56 is secured to the rack 7 by a pair of U-bolts in conventional fashion. The forward end of the basket 56 may be secured to the mounting bracket 26 on the fairlead 24 by means of a length adjustable rod or turnbuckle referred to generally by the reference numeral 58. The lower end of the elongated support 58 is pivotally connected to ears 34 and 36 by pin 48. The upper end of the member 58 is secured to the basket 56 in any convenient means such as by the pin 60 extending through bracket 62 which is secured to the lower forward end of the basket 56.

FIGS. 5 and 6 illustrate that the mounting bracket 26 of this invention may be used as a third attachment point or an additional attachment point for other types of accessories. The mounting bracket 26 and its ability to have the member 58 secured thereto enables the basket 56 to be positioned farther forwardly than would normally be the case which frees up the rearward portion of the rack 17 for other articles or purposes. The structure also allows the mounting of oversized devices on the rack in a forward direction and will allow the mounting of devices forward of the vehicle.

As stated, the accessory mounting bracket 26 provides a common attachment point to allow accessories to be mounted to the top of the ATV, avoiding all of the customization required of a common device (basket, snow plow, snow blower, gun rack, tool rack) or other over center accessories having to be mounted to the front bumper. The attachment bracket 26 provides a common attachment point to a allow an upwardly applied force to lift, move side-to-side, an accessory primarily attached to the ATV in some fashion where a third point of attachment is needed thereby eliminating the customization normally required to fit various ATV bumpers. The attachment bracket 26 eliminates the need for “U” bolts, multiple special brackets, etc., to fit various ATV bumpers. The bracket 26 is designed to universally fit the winch systems of practically all of the winch manufacturers.

Although the winch roller fairlead 24 is described as being at the forward end of the vehicle 10, there are some instances where the winch roller fairlead 24 may be mounted at the rear end of the vehicle 10.

Thus it can be seen that the invention accomplishes at least all of its stated objectives.

We claim:

1. The method of creating an accessory attachment point at the forward end of an all-terrain vehicle having a winch roller fairlead secured thereto which is positioned forwardly of a winch secured to the vehicle and which has a winch cable extending therefrom which is threaded through the winch roller fairlead, comprising the steps of:
attaching an accessory mounting bracket to the winch roller fairlead with the bracket including accessory attachment mounting structure thereon.

2. The method of claim 1 further including the step of attaching the accessory mounting bracket to the winch mounting bracket.

3. The method of claim 1 further including the step of positioning the accessory mounting bracket between the winch and the winch roller fairlead.

4. The method of claim 1 further including the step of attaching a push blade to the vehicle and securing a down pressure device to said accessory mounting bracket and to said push blade so that the down pressure device extends therebetween.

5. The method of claim 4 further including the step of pivotally connecting the down pressure device to the accessory mounting bracket.

6. The method of claim 1 further including the step of attaching an accessory to said accessory mounting bracket.

7. In combination:
an all-terrain vehicle including a wheeled frame having a forward end and a rearward end;
a winch secured to said wheeled frame at the forward end thereof;
said winch including a winch cable extending therefrom;
a fairlead operatively secured to said winch or said wheeled frame forwardly of said winch which has said winch cable extending therethrough;
an accessory support secured to said fairlead adapted to have an all-terrain vehicle accessory secured thereto.

8. The combination of claim 7 wherein said all-terrain vehicle accessory comprises a push blade and wherein a down pressure device is secured to said accessory support and said push blade and extends therebetween.

9. The combination of claim 8 wherein said down pressure device comprises a gas cylinder.

10. The combination of claim 7 wherein said fairlead is a roller fairlead.

11. The combination of claim 7 wherein said winch is secured to said frame by a first bracket and wherein said fairlead is also secured to said first bracket.

12. The combination of claim 11 wherein said accessory support comprises a plate which is secured to said first bracket.

13. The combination of claim 12 wherein said plate has a pair of spaced-apart ears secured thereto to which said accessory is secured.

14. The combination of claim 7 wherein said vehicle includes a rack at its forward end and wherein said accessory comprises a basket secured to said rack and to said accessory support.

15. The combination of claim 14 wherein an elongated, length adjustable member is secured to and extends between said basket and said accessory support.

16. The method of creating an accessory attachment point at one end of an all-terrain vehicle having a winch roller fairlead secured thereto which is positioned adjacent a winch secured to the vehicle and which has a winch cable extending therefrom which is threaded through the winch roller fairlead, comprising the steps of:
attaching an accessory mounting bracket to the winch roller fairlead with the bracket including accessory attachment mounting structure thereon.

17. In combination:
an all-terrain vehicle including a wheeled frame having a forward end and a rearward end;
a winch secured to said wheeled frame at one end thereof;
said winch including a winch cable extending therefrom;
a fairlead operatively secured to said winch or said wheeled frame outwardly of said winch which has said winch cable extending therethrough;
an accessory support secured to said fairlead adapted to have an all-terrain vehicle accessory secured thereto.
